(19) United States
(12) Patent Application Publication
(10) Pub. No.: US 2012/0121008 A1
(43) Pub. Date: May 17, 2012

(54) MEMORY ACCESS DEVICE AND VIDEO PROCESSING SYSTEM

(75) Inventor: Toru MIZUSHIMA, Osaka (JP)

(73) Assignee: Panasonic Corporation, Osaka (JP)

(21) Appl. No.: 13/357,093

(22) Filed: Jan. 24, 2012

Related U.S. Application Data
(63) Continuation of application No. PCT/JP2010/003790, filed on Jun. 7, 2010.

(30) Foreign Application Priority Data
Aug. 5, 2009 (JP) 2009-182464

(51) Int. Cl. H04N 7/26

(52) U.S. Cl. 375/240.02; 375/E07.126

(57) ABSTRACT

Required-bandwidth obtaining units are provided in respective function blocks, and each output required-bandwidth information representing the required bandwidth of a corresponding function block based on the horizontal frequency and the number of effective pixels per period of a horizontal synchronization signal. A memory bus arbiter calculates the sum of the required bandwidths of all the function blocks based on the required-bandwidth information, and determines whether or not the sum of the required bandwidths of all the function blocks exceeds the entire bandwidth of the data bus. If it is determined that the sum of the required bandwidths exceeds the entire bandwidth, the required bandwidth of at least one of the function blocks is reduced, while if it is determined that the sum of the required bandwidths does not exceed the entire bandwidth, all the function blocks access the memory using the required bandwidths at the time of required bandwidth calculation.

### CROSS-REFERENCE TO RELATED APPLICATION

This is a continuation of PCT International Application PCT/JP2010/003790 filed on Jun. 7, 2010, which claims priority to Japanese Patent Application No. 2009-182464 filed on Aug. 5, 2009. The disclosures of these applications including the specifications, the drawings, and the claims are hereby incorporated by reference in its entirety.

### BACKGROUND

The present invention relates to memory access devices for each accessing a memory storing video data over a data bus by a plurality of function blocks, and also relates to video processing systems including such memory access devices.

Japanese Patent Publication No. H08-339346 (Patent Document 1) discloses bus arbiters which each arbitrate access requests from a plurality of bus masters, and grant access to a memory to one of the bus masters.

Japanese Patent Publication No. 2001-297056 (Patent Document 2) discloses direct memory access controllers (DMACs) each including an arbitration circuit which receives access requests for a memory from request sources, and selects one of the access requests.

Japanese Patent Publication No. 2007-323279 (Patent Document 3) discloses a memory control device which arbitrates access requests for a memory issued from a plurality of function blocks. This memory control device includes a FIFO buffer for temporarily storing access requests issued from the function blocks, and determines priorities of the access requests based on the number of access requests stored in the FIFO buffer.

### SUMMARY

Patent Documents 1-3 describe an operation in which access to a memory is granted to one of the plurality of function blocks, but do not describe an operation which allows a plurality of function blocks to simultaneously access to a memory.

One method to allow a plurality of function blocks to simultaneously access to a memory is to assign a predetermined assigned bandwidth to each of the function blocks. However, if the required bandwidth of a function block exceeds the assigned bandwidth by an unforeseen event, this method results in a situation where even if the entire bandwidth of the data bus for accessing the memory is not used up, that function block can no longer function properly, thereby causing the memory access device to fail to operate properly. For example, if the function block is adapted to access video data, a number of artifacts are generated in video images displayed based on the video data, or the system becomes unstable. In addition, the entire bandwidth of the data bus is not effectively used.

In view of the foregoing, it is an object of the present invention to effectively use the bandwidth, thereby to prevent an improper operation of a memory access device due to bandwidth insufficiency.

In order to solve these problems, one aspect of the present invention is a memory access device which makes access to a memory storing video data over a data bus by a plurality of function blocks including, required-bandwidth obtaining units provided in the respective function blocks, and each configured to output required-bandwidth information representing a required bandwidth of a corresponding function block based on a horizontal frequency and on a number of effective pixels per period of a horizontal synchronization signal, and a memory bus arbiter configured to calculate a sum of the required bandwidths of the plurality of function blocks based on the required-bandwidth information output by the required-bandwidth obtaining units, and to determine whether or not the calculated sum exceeds an entire bandwidth of the data bus, where if the memory bus arbiter determines that the sum of the required bandwidths of the plurality of function blocks exceeds the entire bandwidth, the required bandwidth of at least one of the plurality of function blocks is reduced, while if the memory bus arbiter determines that the sum of the required bandwidths of the plurality of function blocks does not exceed the entire bandwidth, the plurality of function blocks make the access using the required bandwidths represented in the required-bandwidth information.

According to this, in the memory access device, if the sum of the required bandwidths of the respective function blocks does not exceed the entire bandwidth, the plurality of function blocks access the memory using the initial required bandwidths. Therefore, the entire bandwidth is effectively used, and thus an improper operation due to bandwidth insufficiency is unlikely to occur.

The present invention allows the entire bandwidth to be effectively used, and thus an improper operation due to bandwidth insufficiency is unlikely to occur. Thus, artifacts are prevented from being generated in video images displayed based on video data stored in the memory, and the system becomes more stable.

### BRIEF DESCRIPTION OF THE DRAWINGS

FIG. 1 is a block diagram schematically illustrating a configuration of a memory access device according to the first embodiment of the present invention.

FIG. 2 is a block diagram illustrating in detail a configuration of a DMAC and the memory bus arbiter according to the first embodiment of the present invention.

FIG. 3 is a block diagram illustrating a configuration of the input/output format determination unit according to the first embodiment of the present invention.

FIG. 4 is an illustrative diagram for explaining a method of calculating the number of effective pixels according to the first embodiment of the present invention.

FIG. 5 is a flowchart illustrating an operation of the memory access device according to the first embodiment of the present invention.

FIG. 6 is a flowchart illustrating an operation of a memory access device according to the second embodiment of the present invention.

FIG. 7 is a block diagram illustrating a configuration of a digital television system having the memory access device according to the first or the second embodiment of the present invention.

### DETAILED DESCRIPTION

Example embodiments of the present invention will be described below with reference to the drawings.

### First Embodiment

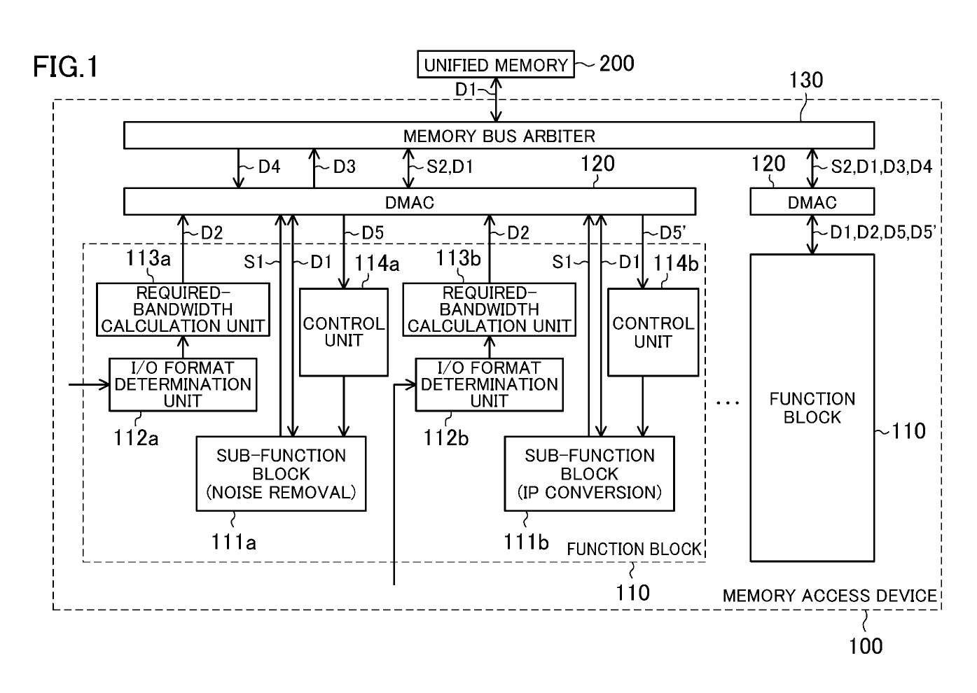

FIG. 1 illustrates a configuration of a memory access device 100 according to the first embodiment of the present invention.

The memory access device 100 includes a plurality of function blocks 110. The plurality of function blocks 110 make access to a unified memory 200 which stores video data, that is, read or write video data (transferred data) D1 from or to the unified memory 200, over a DMA data bus. The function blocks 110 access the unified memory 200 through direct memory access controllers (DMACs) 120 each connected to a corresponding function block 110 and through a memory bus arbiter 130 common to the plurality of function blocks 110. Each of the DMACs 120 receives video data D1 and transfer control signals S1 from the connected function block 110, transfers the video data D1, and generates a transfer request signal (DMA command) S2. The memory bus arbiter 130 receives the video data D1, and transfers the video data D1 to the unified memory 200 based on the transfer request signal S2 generated by the corresponding DMAC 120.

Each of the function blocks 110 includes a sub-function block 111a for performing a noise removal function and a sub-function block 111b for performing an IP conversion function. The functions of the sub-function blocks 111a and 111b require access to the unified memory 200. Each of the function blocks 110 also includes input/output (I/O) format determination units 112a and 112b, required-bandwidth calculation units 113a and 113b, and control units 114a and 114b.

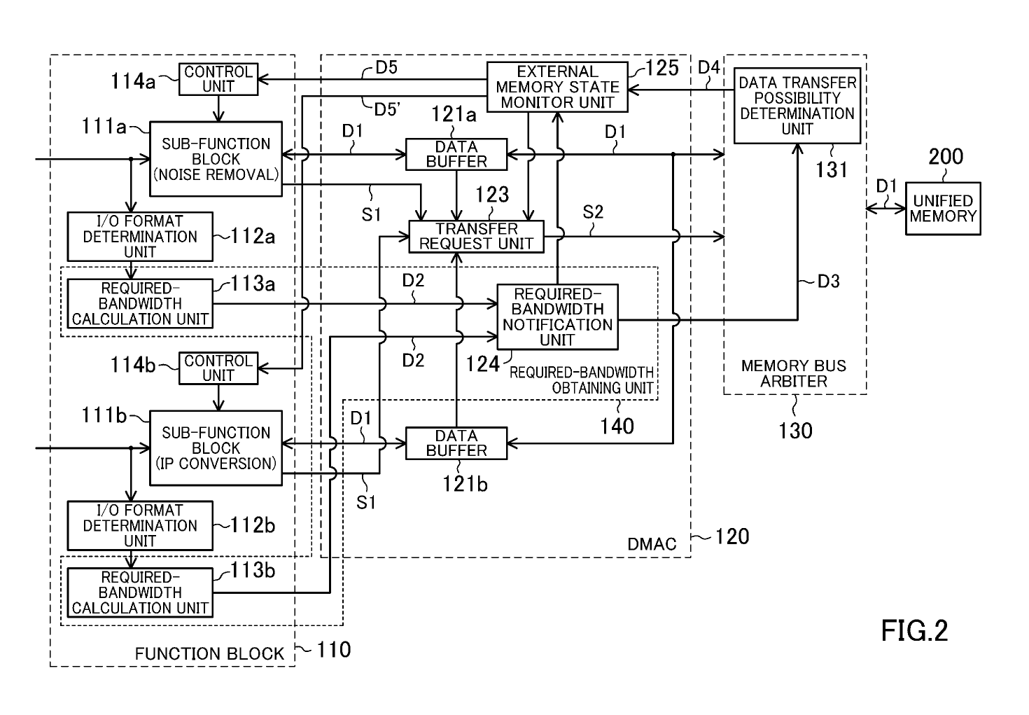

As shown in FIG. 2, each of the DMACs 120 includes a data buffer 121a corresponding to the sub-function block 111a and a data buffer 121b corresponding to the sub-function block 111b. Each of the DMACs 120 also includes a transfer request unit 123, a required-bandwidth notification unit 124, and an external memory state monitor unit 125.

The memory bus arbiter 130 includes a data transfer possibility determination unit 131.

(Basic Access Operation of Memory Access Device 100)

A basic access operation of the memory access device 100 will now be described. For purposes of illustration, one function block 110 and one DMAC 120 corresponding thereto will be described as appropriate. The other function blocks 110 and the other DMACs 120 are configured and operate in a similar manner.

Normally, when the video data D1 is to be stored in the unified memory 200 using a DMA transfer, first the sub-function blocks 111a and 111b output the video data D1 (data to be written) and the transfer control signals S1. The transfer control signals S1 are used to generate the transfer request signal S2. Then, the video data D1 (data to be written) is stored from the sub-function blocks 111a and 111b through a transfer data bus to the data buffers 121a and 121b of the DMAC 120. The transfer request unit 123 generates and outputs the transfer request signal S2 based on the states of the data buffers 121a and 121b and on the transfer control signals S1 output by the sub-function blocks 111a and 111b. When the transfer request signal S2 is received by the memory bus arbiter 130, the video data D1 (data to be written) is sent to the memory bus arbiter 130 over the DMA data bus, and is then forwarded from the memory bus arbiter 130 to the unified memory 200.

Meanwhile, when the sub-function blocks 111a and 111b read video data from the unified memory 200, first the sub-function blocks 111a and 111b output the transfer control signals S1, which are used to generate the transfer request signal S2. Then, the transfer request unit 123 generates and outputs the transfer request signal S2 based on the transfer control signals S1 output by the sub-function blocks 111a and 111b. The memory bus arbiter 130 receives the transfer request signal S2 output by the transfer request unit 123, and reads the video data D1 from the unified memory 200 with appropriate timing. The data read from the memory bus arbiter 130 is sent to the DMAC 120 over the DMA data bus, then is stored in the data buffers 121a and 121b of the DMAC 120, and is sent to the sub-function blocks 111a and 111b over the transfer data bus.

(Configuration for Implementing Access Control Function)

In the memory access device 100, access by each function block 110 is controlled based on the required bandwidth of each function block 110. A configuration for implementing this access control function will be described below.

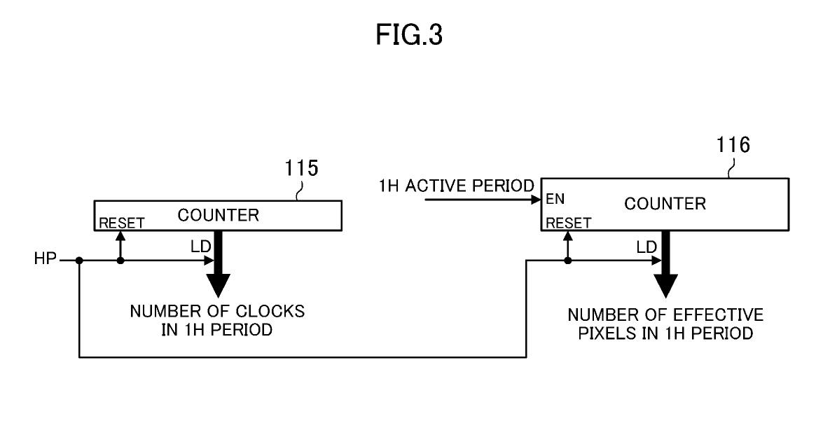

The I/O format determination units 112a and 112b each calculate the frequency of a horizontal synchronization signal and the number of effective pixels per period of the horizontal synchronization signal. The I/O format determination units 112a and 112b each include counters 115 and 116 as shown in FIG. 3.

The counter 115 increments a counter value by one at each rising edge of the system clock. The counter 115 receives a horizontal synchronization signal (designated as “HP” in FIG. 3) of the video data transferred between the corresponding sub-function blocks 111a and 111b and the unified memory 200 (i.e., video data input to, or output from, the sub-function blocks 111a and 111b) as a reset (RESET) signal and a load (LD) signal. Thus, the counter 115 outputs a value representing the number of system clocks per period of the horizontal synchronization signal (1H period). The I/O format determination units 112a and 112b each calculate the frequency of the horizontal synchronization signal, that is, the horizontal frequency, using Equation 1 shown below.

$$Horizontal Frequency ( Hz ) = \frac{System Clock ( Hz )}{Number of System Clocks in 1 H Duration} \qquad ( Equation 1 )$$

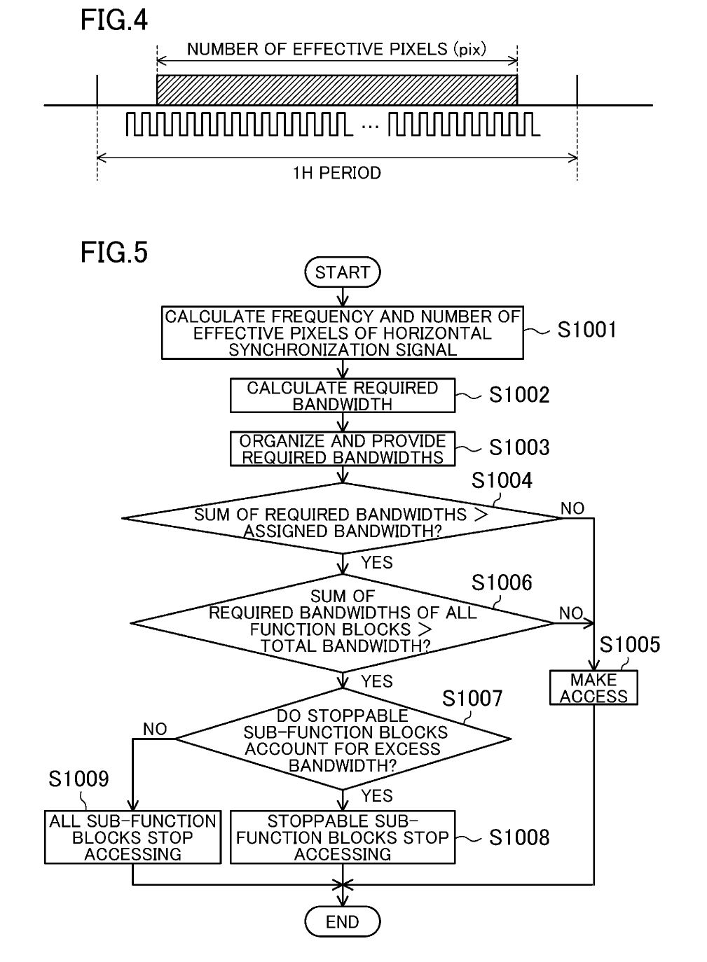

The counter 116 increments a counter value by one at each rising edge of the system clock, using as an enable (EN) signal a signal which transitions to a high logic level during an active period. The counter 116 receives a horizontal synchronization signal (designated as “HP” in FIG. 3) of the video data transferred between the corresponding sub-function blocks 111a and 111b and the unified memory 200 (i.e., video data input to, or output from, the sub-function blocks 111a and 111b) as a reset (RESET) signal and a load (LD) signal for the counter. Thus, the counter 116 outputs the number of effective pixels in a 1H period as shown in FIG. 4.

The required-bandwidth calculation units 113a and 113b respectively calculate required bandwidths of the sub-function blocks 111a and 111b based on the horizontal frequencies and the numbers of effective pixels calculated by the I/O format determination units 112a and 112b. In more detail, the required-bandwidth calculation units 113a and 113b calculate the required bandwidths using Equation 2 shown below.

Required Bandwidth (Mbit/s)=Number of Effective Pixels in 1H Period (pix)*Number of Bits*Horizontal Frequency (MHz) (Equation 2)

With respect to Equation 2 shown above, the number of bits is input to the required-bandwidth calculation units 113a and 113b by a user. Software is used for the input operation. Bandwidth information D2 representing the calculated required bandwidth is sent to the required-bandwidth notification unit 124 in the DMAC 120.

The required-bandwidth notification unit 124 receives the bandwidth information D2 from both the required-bandwidth calculation units 113a and 113b, and sends required-bandwidth information D3 representing required bandwidths of both the sub-function blocks 111a and 111b to the data transfer possibility determination unit 131 of the memory bus arbiter 130 over a bandwidth information bus.

The required-bandwidth calculation units 113a and 113b, and the required-bandwidth notification unit 124 described above constitute a required-bandwidth obtaining unit 140.

The data transfer possibility determination unit 131 of the memory bus arbiter 130 outputs DMA transfer possibility information D4 indicating whether a data transfer can be performed or not and excess bandwidth information representing the excess bandwidth (difference between the sum of the required bandwidths and the total available bandwidth of the DMA data bus) based on the required-bandwidth information D3 sent by the required-bandwidth notification unit 124.

The external memory state monitor unit 125 of the DMAC 120 receives the DMA transfer possibility information D4 output by the data transfer possibility determination unit 131, and generates and outputs function stoppage possibility information D5 and D5′ each indicating whether access can be made or not. The pieces of the function stoppage possibility information D5 and D5′ are generated based on the priorities of the sub-function blocks 111a and 111b, the excess bandwidth information, and the required bandwidths of the sub-function blocks 111a and 111b. Here, the priorities of the respective sub-function blocks 111a and 111b indicate whether or not the functions of the respective sub-function blocks 111a and 111b can be stopped. These priorities are set in advance by software etc.

If the both pieces of the function stoppage possibility information D5 and D5′ indicate “access disallowed,” the transfer request unit 123 of the DMAC 120 stops outputting the transfer request signal S2. Meanwhile, if at least one piece of the function stoppage possibility information D5 or D5′ indicates “access allowed,” the transfer request unit 123 does not stop outputting the transfer request signal S2.

If the function stoppage possibility information D5 indicates “access disallowed,” the control unit 114a outputs a command signal representing OFF to the sub-function block 111a. Meanwhile, if the function stoppage possibility information D5 indicates “access allowed,” the control unit 114a outputs a command signal representing ON to the sub-function block 111a.

Similarly, if the function stoppage possibility information D5′ indicates “access disallowed,” the control unit 114b outputs a command signal representing OFF to the sub-function block 111b. Meanwhile, if the function stoppage possibility information D5′ indicates “access allowed,” the control unit 114b outputs a command signal representing ON to the sub-function block 111b.

If the command signal output by the control unit 114a represents OFF, the sub-function block 111a stops accessing the unified memory 200. Meanwhile, if the command signal represents ON, the sub-function block 111a does not stop accessing the unified memory 200.

Similarly, if the command signal output by the control unit 114b represents OFF, the sub-function block 111b stops accessing the unified memory 200. Meanwhile, if the command signal represents ON, the sub-function block 111b does not stop accessing the unified memory 200.

(Operation to Implement Access Control Function)

The memory access device 100 configured as described above performs an operation illustrated in the flowchart of FIG. 5 with respect to each of the function blocks 110. The operation illustrated in the flowchart of FIG. 5 will be described below.

(S1001) The I/O format determination unit 112a calculates the frequency of the horizontal synchronization signal and the number of effective pixels per period of the horizontal synchronization signal of the sub-function block 111a in the manner described above. Meanwhile, the I/O format determination unit 112b calculates the frequency of the horizontal synchronization signal and the number of effective pixels per period of the horizontal synchronization signal of the sub-function block 111b in the manner described above.

(S1002) The required-bandwidth calculation unit 113a calculates the required bandwidth of the sub-function block 111a using Equation 2 shown above based on the frequency and the number of effective pixels per period of the horizontal synchronization signal calculated by the I/O format determination unit 112a at step S1001. Meanwhile, the required-bandwidth calculation unit 113b calculates the required bandwidth of the sub-function block 111b using Equation 2 shown above based on the frequency and the number of effective pixels per period of the horizontal synchronization signal calculated by the I/O format determination unit 112b at step S1001.

(S1003) The required-bandwidth notification unit 124 organizes the required bandwidths of the sub-function blocks 111a and 111b calculated at step S1002 into the required-bandwidth information D3, and provides the required-bandwidth information D3 to the data transfer possibility determination unit 131 of the memory bus arbiter 130.

(S1004) The data transfer possibility determination unit 131 of the memory bus arbiter 130 calculates the sum of the required bandwidths of both the sub-function blocks 111a and 111b based on the required-bandwidth information D3 provided at step S1003, and then determines whether or not the sum of the required bandwidths exceeds the assigned bandwidth of the function block 110 including the sub-function blocks 111a and 111b. If the sum of the required bandwidths does not exceed the assigned bandwidth, the process proceeds to step S1005. Meanwhile, if the sum of the required bandwidths exceeds the assigned bandwidth, the process proceeds to step S1006. Note that the assigned bandwidth of the function block 110 is set in advance by software.

(S1005) The data transfer possibility determination unit 131 outputs DMA transfer possibility information D4 indicating “data transfer possible.” Upon receiving this DMA transfer possibility information D4, the external memory state monitor unit 125 outputs function stoppage possibility information D5 indicating “access allowed” to the control unit 114a, and outputs function stoppage possibility information D5′ indicating “access allowed” to the control unit 114b. Thus, the sub-function blocks 111a and 111b access the unified memory 200.

(S1006) The data transfer possibility determination unit 131 calculates the sum of the required bandwidths of all the function blocks 110 based on the required-bandwidth information D3 of all the function blocks 110, and determines whether or not the sum exceeds the total bandwidth of the DMA data bus. If the sum of the required bandwidths of all the function blocks 110 does not exceed the total bandwidth, the process proceeds to step S1005. Meanwhile, if the sum of the required bandwidths of all the function blocks 110 exceeds the total bandwidth, the process proceeds to step S1007. The respective pieces of the required-bandwidth information D3 of all the function blocks 110 are generated by performing steps S1001-S1003 for all the function blocks 110. The total bandwidth of the DMA data bus is set in advance by software.

(S1007) The data transfer possibility determination unit 131 outputs DMA transfer possibility information D4 indicating “data transfer not possible” and excess bandwidth information representing the excess bandwidth (difference between the sum of the required bandwidths and the total available bandwidth of the DMA data bus). Both the DMA transfer possibility information D4 and the excess bandwidth information are received by the external memory state monitor unit 125. Thereafter, the external memory state monitor unit 125 generates the function stoppage possibility information D5 and D5′ based on the priorities of the sub-function blocks 111a and 111b, the excess bandwidth information, and the required bandwidths of the sub-function blocks 111a and 111b. In more detail, the external memory state monitor unit 125 determines whether or not the sum of the required bandwidths of the sub-function blocks 111a and 111b for which a status of “stoppable” is indicated by the priority information has reached the excess bandwidth represented by the excess bandwidth information. If the sum of the required bandwidths of the sub-function blocks 111a and 111b for which a status of “stoppable” is indicated has reached the excess bandwidth, the process proceeds to step S1008. Meanwhile, if the sum of the required bandwidths of the sub-function blocks 111a and 111b for which a status of “stoppable” is indicated has not yet reached the excess bandwidth, the process proceeds to step S1009.

(S1008) The external memory state monitor unit 125 sets a value indicating “access disallowed” in the function stoppage possibility information D5 and D5′ corresponding to the sub-function blocks 111a and 111b for which a status of “stoppable” is indicated by the priority information. Thereafter, the transfer request unit 123 stops outputting the transfer request signal S2 based on the function stoppage possibility information D5 and D5′ output by the external memory state monitor unit 125. In addition, the control units 114a and 114b corresponding to the function stoppage possibility information D5 and D5′ indicating a status of “access disallowed” each output a command signal representing OFF. Thus, the sub-function blocks 111a and 111b which have received the command signal representing OFF stop accessing the unified memory 200. That is, the sub-function blocks 111a and 111b for which a status of “stoppable” is indicated by the priority information stop accessing the unified memory 200.

(S1009) The external memory state monitor unit 125 sets a value indicating “access disallowed” in the function stoppage possibility information D5 and D5′ corresponding to all the sub-function blocks 111a and 111b. The transfer request units 123 each stop outputting the transfer request signal S2 based on the function stoppage possibility information D5 and D5′ output by the external memory state monitor unit 125. In addition, all the control units 114a and 114b each output a command signal representing OFF, and thus all the sub-function blocks 111a and 111b stop accessing the unified memory 200.

By performing the operation illustrated in the flowchart of FIG. 5 described above for each of the function blocks 110, if the sum of the required bandwidths of the respective function blocks 110 exceeds the entire bandwidth of the DMA data bus, the required bandwidth of at least one of the plurality of function blocks 110 is reduced. Meanwhile, if the sum of the required bandwidths of the respective function blocks 110 does not exceed the entire bandwidth, all the function blocks 110 make access using the respective required bandwidths represented in the respective required-bandwidth information D3.

Thus, if the sum of the required bandwidths of the respective function blocks 110 does not exceed the entire bandwidth, all the function blocks 110 make access using the initial required bandwidths, and therefore the total bandwidth is effectively used. Accordingly, an improper operation due to bandwidth insufficiency is unlikely to occur.

In addition, at step S1008, only the sub-function blocks 111a and 111b for which a status of “stoppable” is indicated by the priority information stop accessing. Thus, setting the priorities of sub-function blocks as “stoppable” which are required for providing higher image quality but have no effect on video artifacts allows video artifacts to be prevented.

The function blocks 110 may each be configured so as not to include the control units 114a and 114b, but configured such that the sub-function blocks 111a and 111b directly receive the corresponding pieces of the function stoppage possibility information D5 and D5′, respectively, and stop accessing the unified memory 200 based on these pieces of the function stoppage possibility information D5 and D5′.

Moreover, the sub-function blocks 111a and 111b have been described as completely stopping accessing if the respective pieces of the function stoppage possibility information D5 and D5′ indicate “access disallowed.” However, the number of effective pixels or the number of bits of the video data to be accessed may be reduced instead.

### Second Embodiment

In a memory access device 100 according to the second embodiment, if the corresponding command signals output by the corresponding control units 114a and 114b represent OFF, the required-bandwidth calculation units 113a and 113b respectively reduce by one the numbers of bits used for calculation of the required bandwidths. Moreover, if the corresponding command signals output by the corresponding control units 114a and 114b represent OFF, the sub-function blocks 111a and 111b reduce the required bandwidths by reducing by one the number of bits of the video data to be accessed.

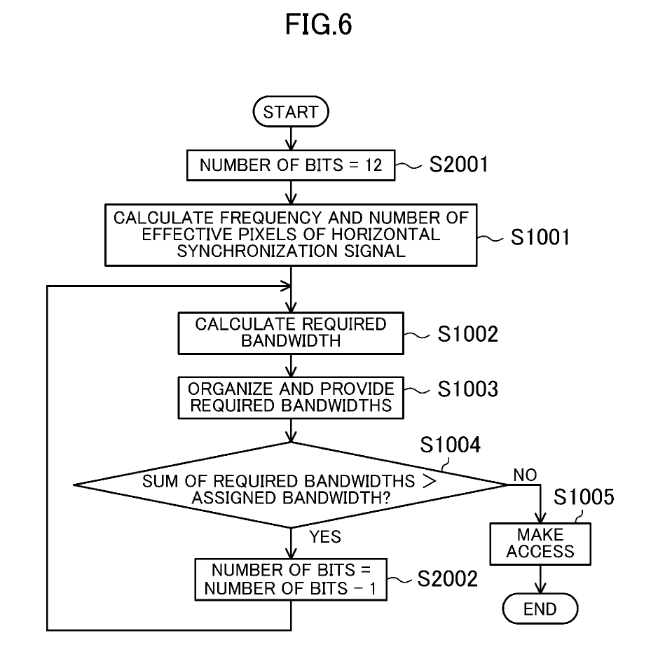

An operation of the memory access device 100 according to this embodiment will be described below by describing the operation illustrated in the flowchart of FIG. 6, in which the same operations as those illustrated in the flowchart of FIG. 5 are designated by the same reference characters, and the explanation thereof will be omitted.

(S2001) The sub-function blocks 111a and 111b each set the number of bits of the video data to be accessed to 12. In addition, the required-bandwidth calculation units 113a and 113b each set the number of bits for use in calculation of the required bandwidths to 12.

(S2002) The sub-function blocks 111a and 111b each reduce the number of bits of the video data to be accessed by one. The number of bits can be reduced, for example, by allowing the brightness signal and the color-difference signals to be independently controlled.

In addition, the required-bandwidth calculation units 113a and 113b each reduce the number of bits for use in calculation of the required bandwidths by one, after which the process returns to step S1002.

The other part of configuration and the other operations are similar to those of the first embodiment, and thus the detailed explanation thereof will be omitted.

Note that, at step S2002, the amount by which the number of bits is reduced by each of the sub-function blocks 111a and 111b and the required-bandwidth calculation units 113a and 113b is not limited to one, but may be more than or equal to two.

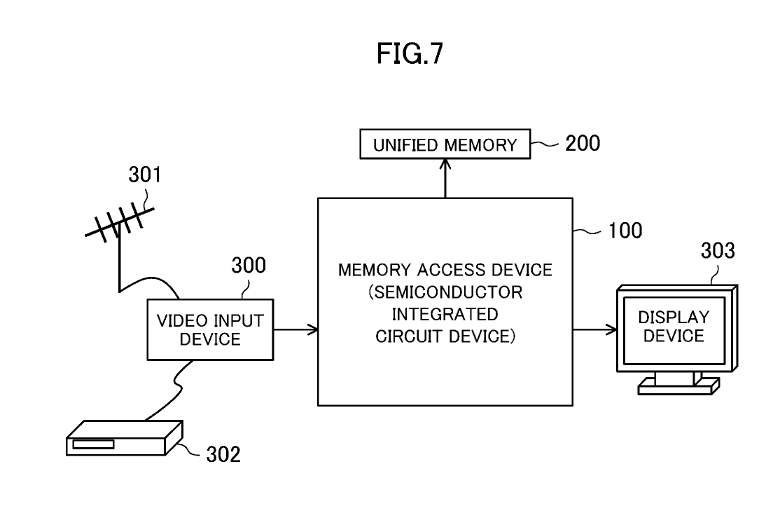

As shown in FIG. 7 for example, the memory access device 100 of the first or the second embodiment is provided in a digital television system including a video input device 300 and a display device 303. The video input device 300 performs a process such as demodulation on a video signal provided by an antenna 301, by a video tape recorder (VTR) 302, etc., and outputs the processed data as video data. Note that the present invention is applicable not only to digital television systems, but also to video processing systems such as digital versatile disc (DVD) recorders and blu-ray disc recorders. In addition, in FIG. 7, the device 302 is not limited to a VTR, but may be a recorder such as a DVD recorder or a blu-ray disc recorder.

In the digital television system of FIG. 7, the memory access device 100 performs video signal processing such as noise removal and IP conversion on the video data output by the video input device 300, and outputs the processed video data. The memory access device 100 accesses the unified memory 200 during the video signal processing.

The display device 303 displays video based on the processed video data output by the memory access device 100.

The first and the second embodiments have been described assuming that each of the function blocks 110 includes the two sub-function blocks 111a and 111b. However, the present invention is also applicable to a case in which each of the function blocks 110 includes three or more sub-function blocks: for example, a sub-function block for resizing is further included.

Although the second embodiment has been described as reducing the required bandwidth of a function block 110 by reducing the number of bits of the video data to be accessed, the required bandwidth of the function block 110 may be reduced by reducing the number of effective pixels, instead of the number of bits.

In the first and the second embodiments, if the sum of the required bandwidths of all the function blocks 110 calculated by the memory bus arbiter 130 is less than the entire bandwidth of the DMA data bus, then the operating frequency of the unified memory 200 may be reduced depending on the required bandwidth. This allows the power consumption to be reduced.

The unified memory 200 may be formed by a plurality of separate memories, to which divided bandwidths of the data bus are respectively assigned, and the separate memories may use the respectively assigned bandwidths for access from the function blocks 110. In this case, if the sum of the required bandwidths of all the function blocks 110 is less than the entire bandwidth of the DMA data bus, then the operation of at least one of the separate memories may be stopped depending on the required bandwidth. This allows the power consumption to be reduced.

In the first and the second embodiments, the required-bandwidth information D3 has been described as representing the required bandwidths of both the sub-function blocks 111a and 111b. However, the required-bandwidth information D3 is not limited thereto as long as the required bandwidth of the function block 110 is represented. For example, the process may be such that the required-bandwidth obtaining unit 140 calculates the sum of the required bandwidths of both the sub-function blocks 111a and 111b, and outputs the sum as the required-bandwidth information D3, and that the memory bus arbiter 130 calculates the sum of the required bandwidths of all the function blocks 110 based on this required-bandwidth information D3.

In the first and the second embodiments, the frequency and the number of effective pixels per period of the horizontal synchronization signal have been described as being automatically calculated by hardware. However, these values may be set manually using software.

The memory access device and the video processing system according to the present invention effectively use the entire bandwidth, and thus are advantageous in that an improper operation due to bandwidth insufficiency is unlikely to occur. Accordingly, the present invention is useful for memory access devices for each accessing a memory storing video data over a data bus by a plurality of function blocks, and video processing systems including such memory access devices.

What is claimed is:

1. A memory access device which makes access to a memory storing video data over a data bus by a plurality of function blocks, comprising:
required-bandwidth obtaining units provided in the respective function blocks, and each configured to output required-bandwidth information representing a required bandwidth of a corresponding function block based on a horizontal frequency and on a number of effective pixels per period of a horizontal synchronization signal; and
a memory bus arbiter configured to calculate a sum of the required bandwidths of the plurality of function blocks based on the required-bandwidth information output by the required-bandwidth obtaining units, and to determine whether or not the calculated sum exceeds an entire bandwidth of the data bus,
wherein
if the memory bus arbiter determines that the sum of the required bandwidths of the plurality of function blocks exceeds the entire bandwidth, the required bandwidth of at least one of the plurality of function blocks is reduced,
while if the memory bus arbiter determines that the sum of the required bandwidths of the plurality of function blocks does not exceed the entire bandwidth, the plurality of function blocks make the access using the required bandwidths represented in the required-bandwidth information.

2. The memory access device of claim 1, wherein
if the memory bus arbiter determines that the sum of the required bandwidths of the plurality of function blocks exceeds the entire bandwidth, the required bandwidth of the at least one of the plurality of function blocks is reduced by reducing a number of effective pixels or a number of bits of video data for which the access is made.

3. The memory access device of claim 1, wherein
each of the plurality of function blocks includes a plurality of sub-function blocks which make access to the memory for reading or writing the video data, and
if the memory bus arbiter determines that the sum of the required bandwidths of the plurality of function blocks exceeds the entire bandwidth, the required bandwidth of the at least one of the plurality of function blocks is reduced by stopping making the access to the memory by at least one of the plurality of sub-function blocks of the at least one of the plurality of function blocks.

4. The memory access device of claim 1, wherein
if the sum of the required bandwidths of the plurality of function blocks calculated by the memory bus arbiter is less than the entire bandwidth, an operating frequency of the memory is reduced.

5. The memory access device of claim 1, wherein
the memory is formed by a plurality of separate memories, to which divided bandwidths of the data bus are respectively assigned, and the separate memories use the respectively assigned bandwidths for access from the plurality of function blocks, and
if the sum of the required bandwidths of the plurality of function blocks calculated by the memory bus arbiter is less than the entire bandwidth, operation of at least one of the separate memories is stopped.

6. A video processing system, comprising:
the memory access device of claim 1;
the memory; and
a display device configured to output video based on video data written in the memory.
